(19) United States
(12) Patent Application Publication
(10) Pub. No.: US 2026/0018053 A1
(43) Pub. Date: Jan. 15, 2026

(54) DRIVER-ASSISTANCE APPARATUS, DRIVER-ASSISTANCE METHOD, AND STORAGE MEDIUM

(71) Applicant: HONDA MOTOR CO., LTD., Tokyo (JP)

(72) Inventors: Srinivasa Divakar BHAT, Wako-shi (JP); Prateek GARG, Wako-shi (JP); Akira KANEHARA, Wako-shi (JP); Masamitsu TSUCHIYA, Wako-shi (JP); Ryuji IWASHITA, Wako-shi (JP); Mudit SONI, Wako-shi (JP); Surbhi AGRAWAL, Wako-shi (JP); Tarun SATHESH, Wako-shi (JP)

(21) Appl. No.: 19/338,406

(22) Filed: Sep. 24, 2025

Related U.S. Application Data
(63) Continuation of application No. PCT/JP2023/013627, filed on Mar. 31, 2023.

(51) Int. Cl. G08G 1/09; G06V 20/58; G06V 20/59; G06V 40/10

(52) U.S. Cl. CPC G08G 1/091; G06V 20/58; G06V 20/597; G06V 40/10

(57) ABSTRACT

A driver-assistance apparatus attached to a moving body acquires a first captured image obtained by capturing a moving direction of the moving body and a second captured image obtained by capturing a driver of the moving body, and calculates a risk that the moving body collides with a passerby outside the moving body on the basis of the first captured image. The apparatus determines whether the driver visually recognizes the passerby on the basis of the second captured image; and causes an output device to output a warning at a warning level based on the calculated risk. When the driver visually recognizes the passerby, the apparatus outputs a warning at a warning level lower than a warning level based on the same risk when the driver does not visually recognize the passerby.

### CROSS-REFERENCE TO RELATED APPLICATION(S)

This application is a continuation of International Patent Application No. PCT/JP2023/013627 filed on Mar. 31, 2023, the entire disclosure of which is incorporated herein by reference.

### TECHNICAL FIELD

The present invention relates to a driver-assistance apparatus, a driver-assistance method, and a storage medium.

### BACKGROUND ART

In recent years, a driver-assistance technology has been proposed in which a video of the periphery of a host vehicle (also referred to as a moving body) captured by a camera installed inside the vehicle is analyzed, and when it is determined that an object in the video is an object requiring attention, a call attention image is displayed at a predicted position of the object requiring attention on a display device (Patent Literature 1).

### CITATION LIST

### Patent Literature

PTL 1: International Publication No. 2019/159344

### SUMMARY OF INVENTION

### Technical Problem

If the driver is warned about attention-requiring objects as they appear by the driver-assistance technology, the driver can pay attention to a highly dangerous object and appropriately avoid danger. On the other hand, since the driver himself/herself also drives while paying attention to the surroundings, the attention call performed by the driver-assistance technology may be excessive.

The present invention has been made in view of the above problem, and an object thereof is to implement a technology capable of performing an appropriate warning in consideration of the situation of the driver.

### Solution to Problem

According to the present invention, a driver-assistance apparatus attached to a moving body is provided, the driver-assistance apparatus comprising: one or more processors; and a memory storing instructions which, when the instructions are executed by the one or more processors, cause the driver-assistance apparatus to: acquire a first captured image obtained by capturing a moving direction of the moving body and a second captured image obtained by capturing a driver of the moving body; calculate a risk that the moving body collides with a passerby outside the moving body on the basis of the first captured image; determine whether the driver visually recognizes the passerby on the basis of the second captured image; and cause an output device to output a warning at a warning level based on the calculated risk, wherein when the driver visually recognizes the passerby, the instructions cause the driver-assistance apparatus to output a warning at a warning level lower than a warning level based on the same risk when the driver does not visually recognize the passerby.

### Advantageous Effects of Invention

According to the present invention, it is possible to issue an appropriate warning in consideration of the situation of the driver.

Other features and advantages of the present invention will be apparent from the following description taken in conjunction with the accompanying drawings. Note that the same reference numerals denote the same or like components throughout the accompanying drawings.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a diagram schematically illustrating an example of a configuration of a moving body (vehicle) according to an embodiment.

FIG. 2A is a diagram schematically illustrating an external configuration example of a dashcam as an example of a driver-assistance apparatus according to the embodiment.

FIG. 2B is a diagram schematically illustrating an external configuration of an output device according to the embodiment.

FIG. 3 is a block diagram illustrating a hardware configuration example of the dashcam according to the embodiment.

FIG. 4 is a block diagram illustrating a functional configuration example of the dashcam according to the embodiment.

FIG. 5 is a diagram for describing an example of setting a warning level according to the embodiment.

FIG. 6A is a diagram illustrating a specific example of an environment level according to the embodiment.

FIG. 6B is a diagram illustrating a specific example of setting of a warning level according to the embodiment.

FIG. 7 is a flowchart illustrating a series of operations of driver-assistance processing according to the embodiment.

FIG. 8 is a flowchart illustrating a series of operations of driver-assistance processing according to the embodiment.

FIG. 9 is a diagram for describing an example of notification by the output device according to the embodiment.

FIG. 10 is a diagram for describing an example of notification by the output device according to the embodiment.

FIG. 11 is a diagram illustrating an example of notification by an output device according to another embodiment.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Embodiment 1

The present embodiment describes, as an example, a case where a driver-assistance apparatus is a dashcam that is attached inside a vehicle, captures the front, side, and rear of the vehicle, and records the traveling state of the vehicle on a recording medium. However, the driver-assistance apparatus may be a device other than a dashcam as long as the driver-assistance apparatus is attached to a vehicle and can capture the exterior view of the vehicle. Furthermore, the following embodiment will be described based on an example where the moving body is, for example, a vehicle. The vehicle is typically a four-wheeled vehicle, but the present embodiment may be applied to other types of vehicles.

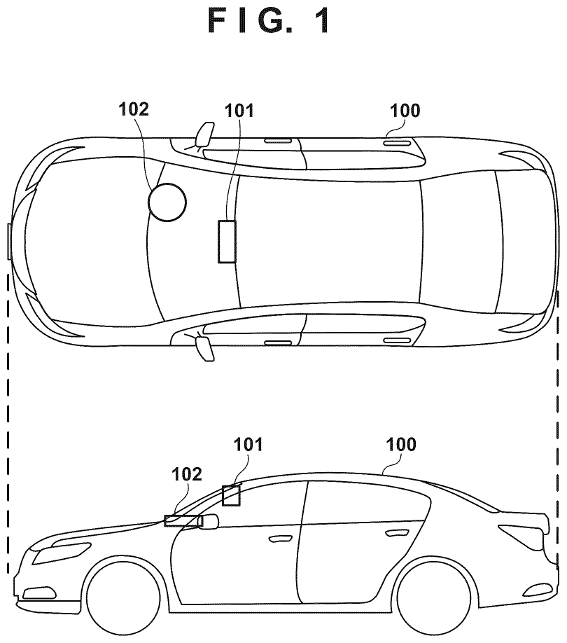

An example of a position where the dashcam is attached will be described with reference to FIG. 1. A dashcam 101 is attached to a vehicle 100. The dashcam 101 is attached to a position that does not obstruct the driver's view, the position being either on a windshield of the vehicle 100 near a rear-view mirror or on the rear-view mirror of the vehicle 100. The attachment position of the dashcam 101 is not limited to such a position, and may be any position as long as the image of the exterior view seen from the vehicle 100 can be captured.

For example, the dashcam 101 can transmit information required to be output to the driver to an external output device 102 wirelessly or by wire, and cause the output device 102 to output the transmitted warning. Note that in the description of the present embodiment, a case where the output device 102 is an external device of the dashcam 101 will be described as an example. However, the dashcam 101 may include an output device (that is, a display for displaying or a speaker for outputting audio).

### <External Configuration Example of Dashcam>

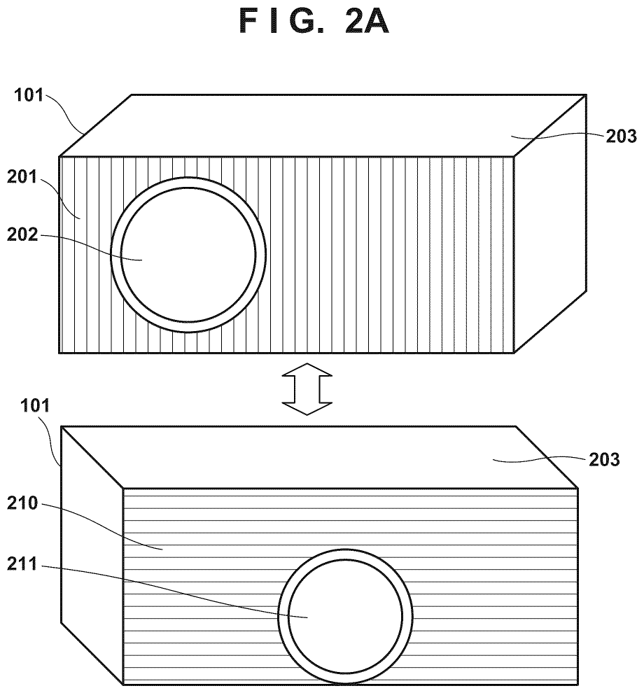

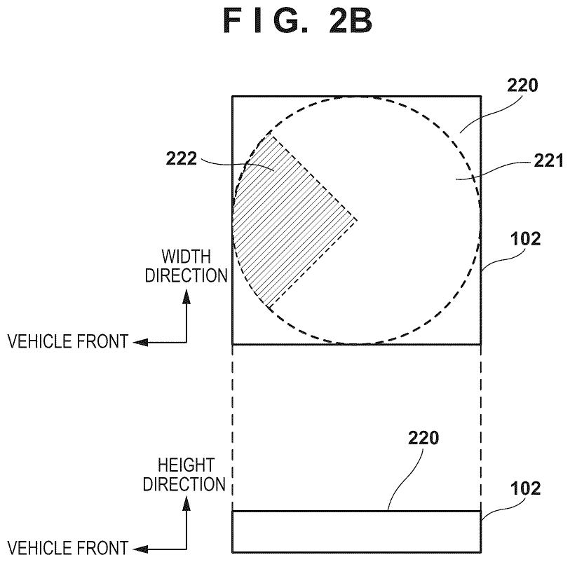

An external configuration example of the dashcam 101 will be described with reference to FIG. 2A. The dashcam 101 includes an image capturing device 202 on a front surface 201, and captures an image of the forward direction (moving direction) of the vehicle 100. The image capturing device 202 is, for example, an image capturing device including a wide-angle lens. In addition, the dashcam 101 includes an image capturing device 211 on a back surface 210, and captures images of the side and the rear of the vehicle 100. The image capturing device 211 is, for example, an image capturing device including a fisheye lens. The image captured by the image capturing device 211 includes the driver of the vehicle 100. Reference numeral 203 represents an upper surface of the dashcam 101.

### <External Configuration Example of Output Device>

An external configuration example of the output device 102 will be described with reference to FIG. 2B. The output device 102 is a device for outputting information to the occupant of the vehicle 100. The output device 102 includes a display device (for example, a display or a light emitting element) that provides visual information and a sound device (for example, a speaker) that provides auditory information. The output device 102 performs wireless or wired communication with the dashcam 101 to display information on the display device.

The output device 102 includes a display device on its upper surface 220. The output device 102 can color display a partial region (for example, 222) in a circle 221 representing the periphery of the vehicle 100 in response to an instruction from the dashcam 101. The colored region 222 serves as a warning output to the driver or the like that a risk is present in the corresponding direction. The output device 102 is installed, for example, on a dashboard near a driver's seat of the vehicle 100. The output device 102 may further include a half mirror to reflect light output from the upper surface 220 toward the driver.

### <Hardware Configuration Example of Dashcam>

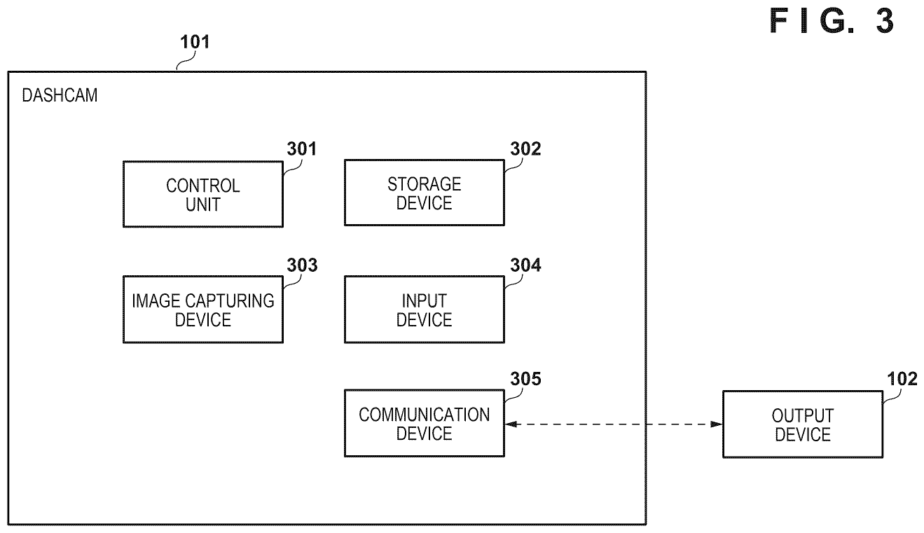

A hardware configuration example of the dashcam 101 will be described with reference to FIG. 3. The dashcam 101 includes, for example, a control unit 301, a storage device 302, an image capturing device 303, an input device 304, and a communication device 305.

The control unit 301 includes, for example, a processor such as a central processing unit (CPU) and controls the overall operation of the dashcam 101. The control unit 301 may be implemented by, for example, a program stored in the storage device 302 that is loaded and executed by the CPU. The control unit 301 may further include, in addition to the CPU, a graphics processing unit (GPU) and a circuit designed specifically for image processing, machine learning, or the like.

The storage device 302 is a device that stores data and a program related to the operation of the dashcam 101. For example, the storage device 302 may store a program that defines the operation of the dashcam 101, temporary data used during the execution of the program, an image captured by the image capturing device 303, an ambient sound picked up by a microphone, and the like. The storage device 302 may be implemented by a memory such as a random access memory (RAM) or a read only memory (ROM). Furthermore, the storage device 302 may further include a secondary storage device such as a solid state drive (SSD).

The image capturing device 303 includes a camera for capturing a front exterior view seen from the vehicle 100. The image capturing device 303 may be, for example, a wide-angle camera. This camera is the above-described image capturing device 202 located on the front side of the dashcam 101 (the front side of the vehicle 100). Furthermore, the image capturing device 303 includes a camera capable of capturing the rear, and left and right sides of the vehicle 100, that is, the above-described image capturing device 211. This camera may be a camera with a fisheye lens. The camera that captures the rear is disposed on the rear side of the dashcam (the rear side of the vehicle). In the present embodiment, a case where the rear and the sides of the vehicle are captured by the same camera will be described as an example. However, the camera that captures the rear and the camera that captures the sides may be separate cameras. The side capturing camera may be disposed on a side surface of the dashcam. Some of the cameras that capture images in a plurality of directions may be provided separately from the dashcam.

The input device 304 is a device for receiving an instruction from an occupant of the vehicle 100. The input device 304 includes, for example, a button or a touchscreen. Moreover, the input device 304 may include a microphone that receives a voice of the occupant or an ambient sound.

The communication device 305 is a device for the dashcam 101 to communicate with the output device 102 in a wired or wireless manner. The communication device 305 transmits warning information generated through driver-assistance processing performed by the control unit 301 to the output device 102. The communication device 305 may communicate with another device in a wired or wireless manner. Wireless communication may be communication compliant with a protocol such as for short-range communication (for example, Bluetooth (registered trademark)). The communication device 305 may be capable of communicating with a control ECU of the vehicle 100 in a wired or wireless manner. The communication device 305 may be optional.

### <Functional Configuration Example of Dashcam>

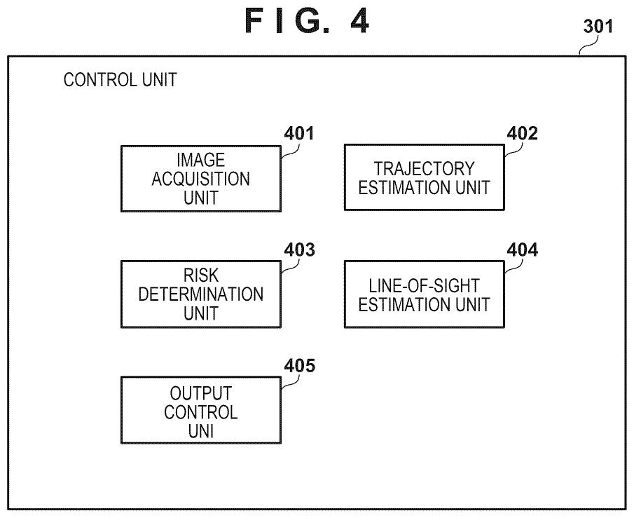

A functional configuration example implemented by the control unit 301 of the dashcam 101 will be described with reference to FIG. 4. Each unit illustrated in FIG. 4 is implemented, for example, by the CPU of the control unit 301 executing a computer program.

An image acquisition unit 401 acquires a front captured image from the image capturing device 202 that captures the front of the dashcam 101. Furthermore, the image acquisition unit 401 acquires a rear captured image from the image capturing device 211 that captures the rear side of the dashcam 101. The rear captured image includes the driver in the image.

A trajectory estimation unit 402 estimates a trajectory on which the vehicle 100 moves and a trajectory on which the passerby moves on the basis of the front captured image. The passerby includes, for example, a pedestrian and a person riding a bicycle. The estimation of the trajectory on which the vehicle 100 moves and the estimation of the trajectory on which the passerby moves in the image may be made by inputting a front captured image to one or more neural networks, for example. A known technology can be used as a method of estimating a trajectory on which the vehicle 100 moves on the basis of a captured image and a method of estimating a trajectory on which a passerby in an image moves on the basis of a captured image. The trajectory on which the passerby moves may be estimated on the basis of, for example, the direction of the body and the direction of the face of the passerby estimated from the front captured image.

On the basis of the trajectory of the vehicle 100 and the trajectory of the passerby estimated by the trajectory estimation unit 402, a risk determination unit 403 calculates the length of the predicted time until the vehicle 100 collides with the passerby and the distance of the passerby from the trajectory on which the vehicle 100 travels. Then, stepwise risks of collision (also referred to as an environmental risk) are determined on the basis of the calculated length of time and the distance to the passerby. The environmental risk is divided into three stages such as a low level, a medium level, and a high level. Note that the environmental risk is not limited thereto, and the risk may be classified into more stages.

A line-of-sight estimation unit 404 estimates whether the driver visually recognizes a passerby by using the rear captured image included in the image. For example, the line-of-sight estimation unit 404 estimates the direction of the face and the direction of the line of sight of the driver using the rear captured image. The direction of the face and the direction of the line of sight of the driver may be estimated by inputting the rear captured image to one or more neural networks, for example. The line-of-sight estimation unit 404 estimates whether the driver visually recognizes the passerby on the basis of, for example, the trajectory of the passerby (the position viewed from the dashcam 101) obtained by the trajectory estimation unit 402 and the direction of the face and direction of the line of sight of the driver.

An output control unit 405 determines a warning level corresponding to the environmental risk determined by the risk determination unit 403 and whether or not the driver visually recognizes a passerby, and causes the output device 102 to output a warning corresponding to the warning level. A specific example of the warning level according to the environmental risk and the presence or absence of visual recognition will be described later.

### <Warning Output by Driver-Assistance Processing>

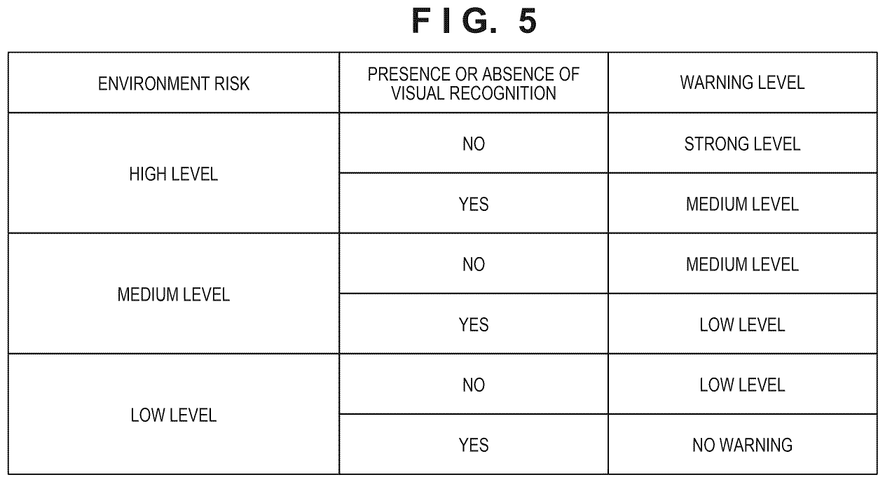

A warning output by driver-assistance processing according to the present embodiment will be described with reference to FIG. 5. FIG. 5 illustrates a relationship between the environmental risk determined by the risk determination unit 403 and a warning level of a warning output from the output device.

The output control unit 405 causes the output device to output a warning at a warning level based on the calculated environmental risk. When the environmental risk is the same, the warning level is varied depending on whether or not the driver visually recognizes the passerby. Specifically, when the driver visually recognizes the passerby, a warning is output at a warning level lower than a warning level based on the same risk when the driver does not visually recognize the passerby. For example, when the environmental risk is “high level” and the driver does not visually recognize the passerby, the warning is output at “strong level”. On the other hand, when the environmental risk is “high level” and the driver visually recognizes the passerby, the warning is output at “medium level”. The warning of “medium level” is at the same level as the warning when the environmental risk is “medium level” and the driver does not visually recognize the passerby. In this way, even when the risk is high in the situation of the vehicle and the passerby, if the driver visually recognizes the passerby, the driver can immediately perform a necessary operation, and thus it is not necessary to perform a high-intensity notification. That is, by not excessively calling the driver's attention, it is possible to reduce the driver's feeling that the warning is bothersome. On the other hand, when the driver does not visually recognize the passerby, it is possible to output a warning at a warning level corresponding to the environmental risk to call attention to the driver. In this manner, it is possible to issue an appropriate warning in consideration of the situation of the driver.

When the risk is higher than a predetermined risk value (for example, a high level) and the driver does not visually recognize the passerby (that is, the warning level is a strong level), the output control unit 405 outputs a warning accompanied by sound. Alternatively, the output control unit 405 may be configured not to output a warning accompanied by sound when the driver visually recognizes the passerby. That is, by outputting a warning accompanied by sound, it is possible to output a warning that draws attention easily only at the most necessary time, and it is possible to prevent an attention call with excessively high intensity from being performed when a passerby is visually recognized.

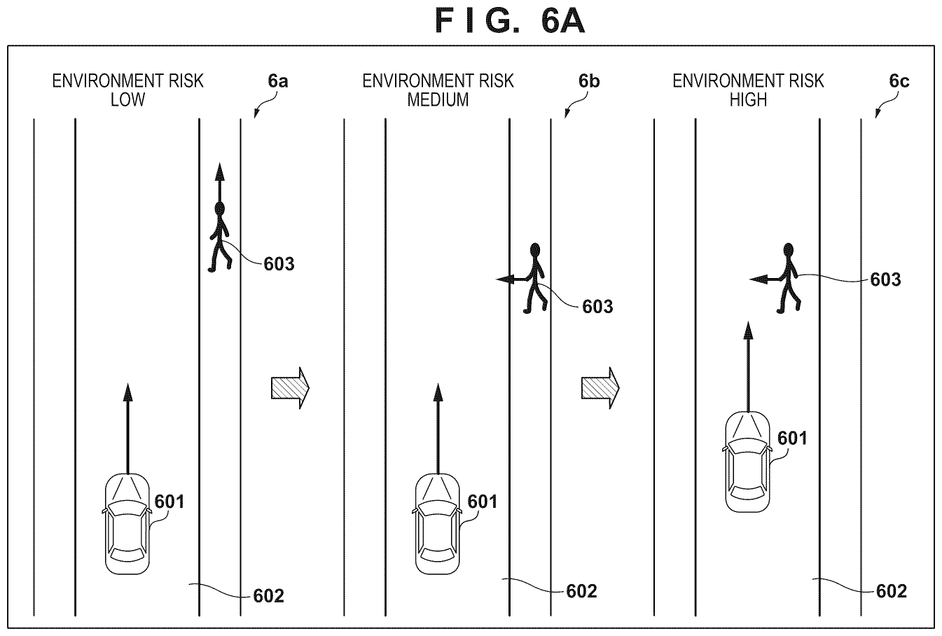

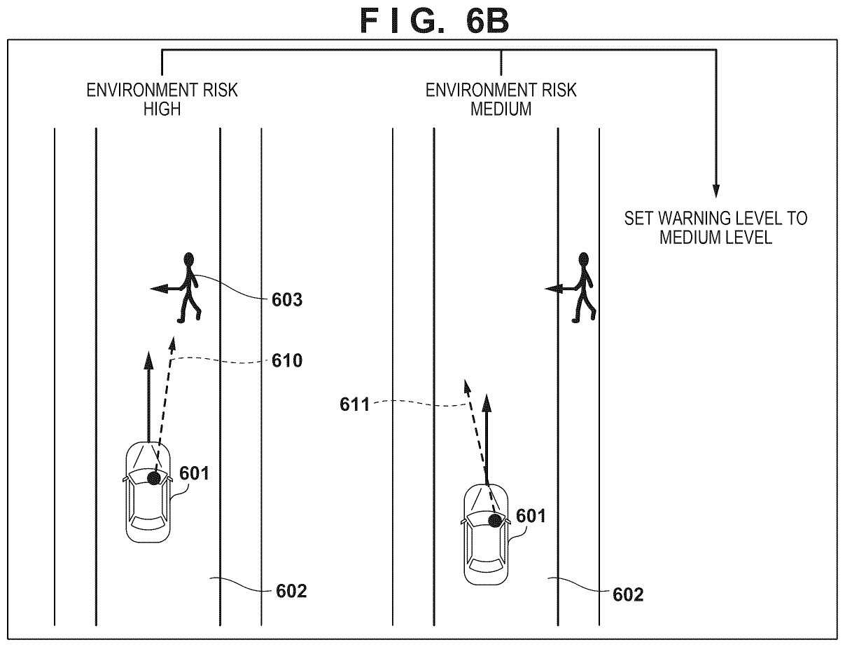

FIG. 6A illustrates a specific example of the environment level according to the embodiment. Reference numeral 6a in FIG. 6A illustrates an example of a case where the environmental risk is “low level”. When a vehicle 601 is traveling on a road 602, a passerby 603 is passing through the sidewalk. The risk determination unit 403 sets the environmental risk to “low level” on the basis of the length of the predicted time until the vehicle 601 and the passerby 603 collide with each other, estimated from the trajectories of the vehicle 601 and the passerby 603, and the distance of the passerby 603 from the trajectory on which the vehicle 601 travels.

Reference numeral 6b in FIG. 6A illustrates an example of a case where the environmental risk is “medium level”. While the vehicle 601 is traveling on road 602, the passerby 603 is traveling on the sidewalk in the direction of road 602. The risk determination unit 403 sets the environmental risk to “medium level” on the basis of the length of the predicted time until the vehicle 601 and the passerby 603 collide with each other estimated from the trajectories of the vehicle 601 and the passerby 603, and the distance of the passerby 603 from the trajectory on which the vehicle 601 travels.

Reference numeral 6c in FIG. 6A illustrates an example of a case where the environment level is “high level”. While the vehicle 601 is traveling on the road 602, the passerby 603 is crossing the road. The risk determination unit 403 sets the environmental risk to “high level” on the basis of the length of the predicted time until the vehicle 601 and the passerby 603 collide with each other, estimated from the trajectories of the vehicle 601 and the passerby 603, and the distance of the passerby 603 from the trajectory on which the vehicle 601 travels.

FIG. 6B illustrates a specific example of setting the warning level according to the embodiment. For example, when the environmental risk is “high level” and it is estimated that the driver of the vehicle 601 visually recognizes the passerby 603 (as in a line of sight 610, by the line-of-sight estimation unit 404), the warning is output at “medium level”. Moreover, when the environmental risk is “medium level” and it is estimated that the driver of the vehicle 601 does not visually recognize the passerby 603 (as in a line of sight 611, by the line-of-sight estimation unit 404), the warning is output at “medium level”.

### <Series of Operations of Driver-Assistance Processing in Dashcam>

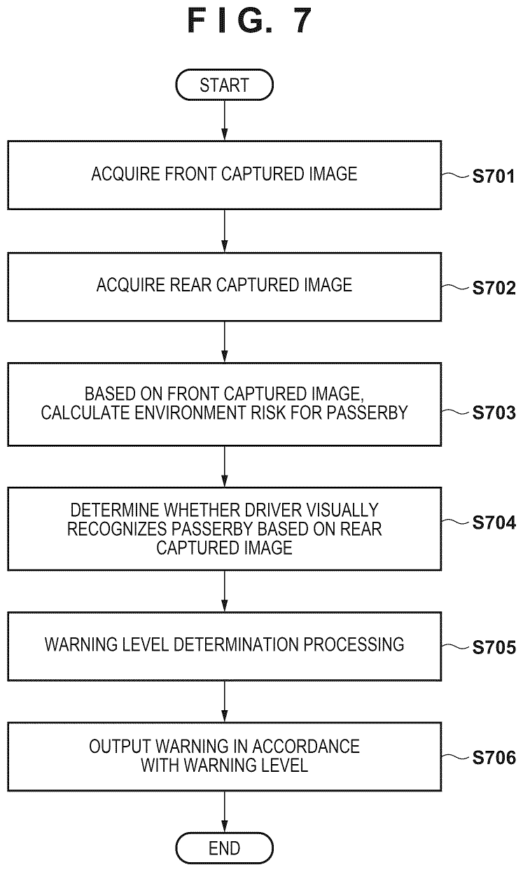

Next, a series of operations of the driver-assistance processing executed in the dashcam 101 will be described with reference to FIG. 7. Note that this processing is implemented by the CPU) of the control unit 301 executing a computer program stored in the storage device 302.

In S701, the image acquisition unit 401 acquires a front captured image obtained by capturing the front of the dashcam 101. The front captured image includes a road on which the vehicle travels and a passerby. In S702, the image acquisition unit 401 acquires a rear captured image obtained by capturing the rear of the dashcam 101. The rear captured image includes the face of the driver.

In step S703, the risk determination unit 403 determines an environmental risk for the passerby on the basis of the front captured image. Specifically, first, the trajectory estimation unit 402 estimates the trajectory of the vehicle 100 and the trajectory of the passerby using the front captured image. As described above, the risk determination unit 403 calculates the length of the predicted time until the vehicle 100 collides with the passerby and the distance of the passerby from the trajectory on which the vehicle 100 travels on the basis of the trajectories of the vehicle 100 and the passerby. Then, the stepwise risks of collision (environmental risk) are determined on the basis of the calculated length of time and the distance to the passerby.

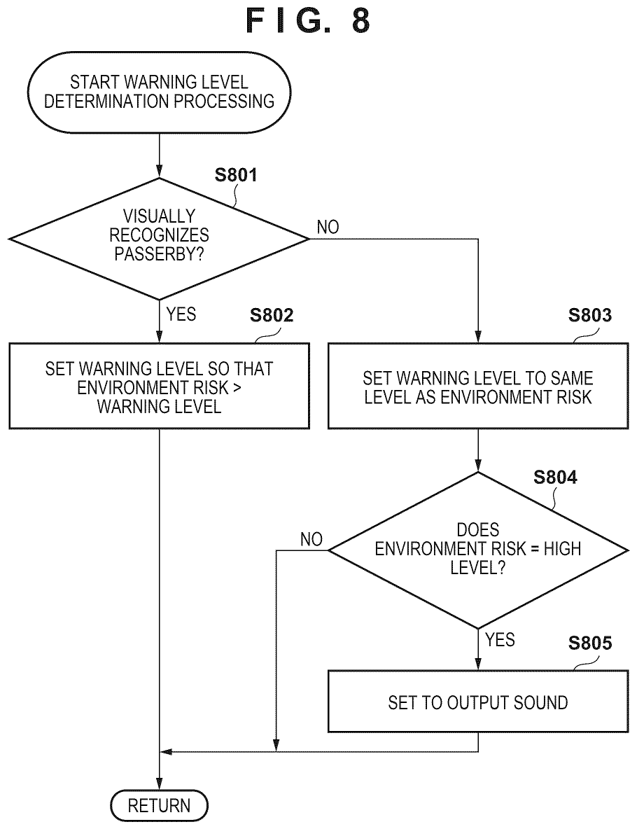

In S704, the line-of-sight estimation unit 404 determines whether the driver visually recognizes the passerby on the basis of the rear captured image. In S705, the output control unit 405 performs warning level determination processing. The warning level determination processing will be described with reference to FIG. 8. In S706, the output control unit 405 causes the output device 102 to output a warning according to the warning level.

### <Series of Operations of Warning Level Determination Processing>

Next, warning level determination processing will be described with reference to FIG. 8.

In S801, the output control unit 405 determines whether the driver visually recognizes a passerby using the estimation result by the line-of-sight estimation unit 404. The output control unit 405 advances the processing to S802 when the driver visually recognizes the passerby, and advances the processing to S803 otherwise.

In S802, the output control unit 405 sets a warning level lower than the environmental risk determined in S703. Thereafter, the output control unit 405 returns the processing to the caller.

In S803, the output control unit 405 sets the warning level to the same level as the environmental risk (because the driver does not visually recognize the passerby). In S804, the output control unit 405 determines whether the environmental risk is at a high level. If the environmental risk is at a high level, the processing proceeds to S805, and if not, the processing returns to the caller.

In S805, the output control unit 405 performs setting so as to output sound when outputting a warning. In this way, in a case where the risk is high and the passerby is not visually recognized, it is possible to output a strong warning accompanied by sound and to strongly call attention.

Note that the output control unit 405 may perform the following processing after determining that the environmental risk is “high level” and the driver visually recognizes the passerby, and once outputting a warning of “medium level”. For example, the output control unit 405 may cause a warning of “high level” to be output when it is determined that the driver's line of sight to the passerby has deviated, using a further estimation result by the line-of-sight estimation unit 404. In this way, it is possible to use the high-level warning to strongly call attention to a passerby from whom the line of sight has deviated. In addition, the output control unit 405 may set the warning level to the high level in a case where the predicted time until the vehicle 100 collides with the passerby after the warning of “medium level” is output becomes shorter than a predetermined time. Furthermore, the output control unit 405 may output the warning at “high level” in a case where a predetermined time elapses with the environmental risk remaining at “high level” after the warning at “medium level” is output. In this way, even when the warning is output once, it is possible to strongly call attention to urge an action for avoiding the risk of collision.

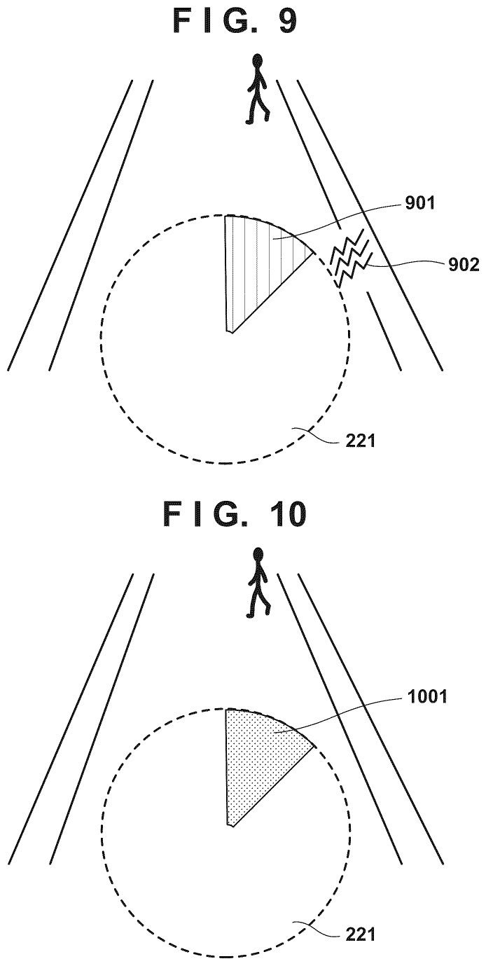

FIG. 9 schematically illustrates an example in which the output control unit 405 causes the output device 102 to output the warning of “high level” in S705. The output device 102 displays a warning 901 indicating a direction in which a passerby is present in a partial region of the circle 221. By indicating the direction in which the passerby is present by the warning 901, the driver can quickly and easily grasp where the warning target is around. In addition, the output device 102 outputs a warning accompanied by sound 902.

FIG. 10 schematically illustrates an example in which the output control unit 405 causes the output device 102 to output the warning of “medium level” in S705. Here, the output control unit 405 varies the display mode of a warning 1001 indicating the direction in which the passerby is present according to the warning level. For example, the warning 901 and the warning 1001 have different display modes. For example, the warning 901 may be displayed in a color such as red in which the height of the risk is easily recognized, and the warning 1001 may be displayed in the complementary color of the warning 901. For example, the output control unit 405 can display the warning in a display mode with higher saturation or brightness as the warning level is higher. In this way, the driver can intuitively grasp the warning level of the warning, that is, the level of risk. In addition, the dashcam 101 can call attention in a more conspicuous display mode as the warning level is higher.

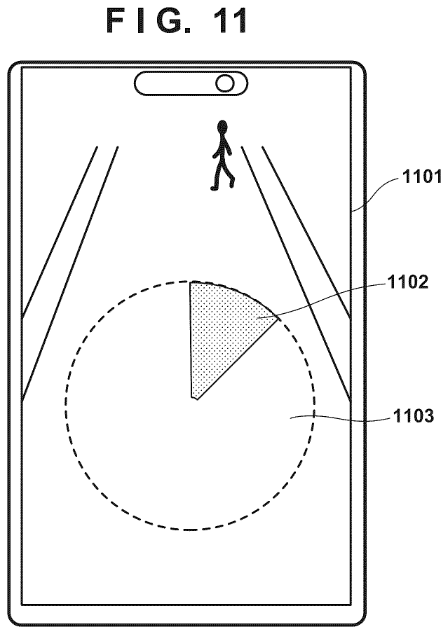

Note that in the above-described embodiment, the case where the warning is output by the output device 102 has been described as an example, but the warning may be output by at least one of a smartphone, a tablet terminal, a head-mounted display, and a wearable terminal. These devices communicate with the dashcam 101 wirelessly or by wire, and cause a display device 1101 of the device to display a warning 1102 in a circle 1103 as illustrated in FIG. 11. The warning 1102 may be superimposed on a front captured image on the display device 1101.

### SUMMARY OF EMBODIMENTS

1. A driver-assistance apparatus (for example, 101) of the above embodiment is a driver-assistance apparatus attached to a moving body (for example, 100), the driver-assistance apparatus comprising:
image capturing means (for example, 303) for acquiring a first captured image obtained by capturing a moving direction of the moving body and a second captured image obtained by capturing a driver of the moving body;
risk calculation means (for example, 403) for calculating a risk that the moving body collides with a passerby outside the moving body on the basis of the first captured image;
determination means (for example, 404) for determining whether the driver visually recognizes the passerby on the basis of the second captured image; and
output control means (for example, 405) for causing an output device to output a warning at a warning level based on the calculated risk, characterized in that
when the driver visually recognizes the passerby, the output control means outputs a warning (for example, 901, 902, 1001, 1102) at a warning level lower than a warning level based on the same risk when the driver does not visually recognize the passerby.

According to this embodiment, it is possible to issue an appropriate warning in consideration of the situation of the driver.

2. In the driver-assistance apparatus of the above embodiment, the output control means outputs a warning at a first warning level when the risk is a first risk and the driver does not visually recognize the passerby (for example, 611), and outputs a warning at the first warning level when the driver visually recognizes the passerby even when the risk is a second risk higher than the first risk (for example, 610).

According to this embodiment, by not excessively calling the driver's attention, it is possible to reduce the driver's feeling that the warning is bothersome.

3. In the driver-assistance apparatus of the above embodiment, the output control means outputs a warning at a warning level higher than the first warning level when a predetermined time elapses with the risk remaining at the second risk after outputting the warning at the first warning level.

According to this embodiment, even when the warning is output once, it is possible to strongly call attention to urge an action for avoiding the risk of collision.

4. In the driver-assistance apparatus of the above embodiment, the output control means outputs a warning at a warning level higher than the first warning level when a predicted time until collision becomes shorter than a predetermined time with the risk remaining at the second risk after outputting the warning at the first warning level.

According to this embodiment, even when the warning is output once, it is possible to strongly call attention to urge an action for avoiding the risk of collision.

5. In the driver-assistance apparatus of the above embodiment, the output control means outputs a warning at a warning level higher than the first warning level when the driver does not visually recognize the passerby after outputting the warning at the first warning level.

According to this embodiment, high-level warning is used to strongly call attention to a passerby from whom the line of sight has deviated.

6. In the driver-assistance apparatus of the above embodiment, the output control means outputs a warning (for example, 901, 902) accompanied by sound when the risk is higher than a predetermined risk value and the driver does not visually recognize the passerby.

According to this embodiment, it is possible to output a warning that draws attention easily only at the most necessary time.

7. In the driver-assistance apparatus of the above embodiment, the output control means does not output a warning accompanied by sound when the driver visually recognizes the passerby.

According to this embodiment, it is possible to prevent an attention call with excessively high intensity from being performed when the driver visually recognizes the passerby.

8. In the driver-assistance apparatus of the above embodiment, the output control means causes the output device to output a warning (for example, 901, 1001, 1102) indicating a direction in which the passerby is present.

According to this embodiment, the driver can quickly and easily grasp where the warning target is around.

9. In the driver-assistance apparatus of the above embodiment, the output control means varies a display mode of a warning indicating a direction in which the passerby is present according to a warning level.

According to this embodiment, the driver can intuitively grasp the warning level of the warning, that is, the level of risk.

10. In the driver-assistance apparatus of the above embodiment, the output control means displays the warning in a display mode with higher saturation or brightness as the warning level is higher.

According to this embodiment, it is possible to call attention in a more conspicuous display mode as the warning level is higher.

11. In the driver-assistance apparatus of the above embodiment, the output device is included in the driver-assistance apparatus.

According to this embodiment, it is possible to perform driver assistance with an easily installable configuration by a single driver-assistance apparatus.

12. In the driver-assistance apparatus of the above embodiment, the driver-assistance apparatus causes a display device of the output device to display the warning by communicating with the output device wirelessly or by wire.

According to this embodiment, the output device can be disposed at a position easily perceived by the driver.

13. In the driver-assistance apparatus of the above embodiment, the output device is at least one of a smartphone, a tablet terminal, a head-mounted display, and a wearable terminal.

According to this embodiment, a separately used device can be used as the output device, and the manufacturing cost of the driver-assistance apparatus can be reduced.

14. A driver-assistance method of the above embodiment is a driver-assistance method in which each step is executed by a driver-assistance apparatus (for example, 101) attached to a moving body (for example, 100), the driver-assistance method comprising:
acquiring (for example, S701, S702) a first captured image obtained by capturing a moving direction of the moving body and a second captured image obtained by capturing a driver of the moving body;
calculating (for example, S703) a risk that the moving body collides with a passerby outside the moving body on the basis of the first captured image;
determining (for example, S704) whether the driver visually recognizes the passerby on the basis of the second captured image; and
causing (for example, S706) an output device to output a warning at a warning level based on the calculated risk, characterized in that
when the driver visually recognizes the passerby, the causing a warning to be output includes causing a warning to be output at a warning level lower than a warning level based on the same risk when the driver does not visually recognize the passerby.

According to this embodiment, it is possible to issue an appropriate warning in consideration of the situation of the driver.

15. A program of the above embodiment is a program for causing a computer to function as each means of a driver-assistance apparatus (for example, 101) attached to a moving body (for example, 100), the driver-assistance apparatus comprising:
image capturing means (for example, 303) for acquiring a first captured image obtained by capturing a moving direction of the moving body and a second captured image obtained by capturing a driver of the moving body;
risk calculation means (for example, 403) for calculating a risk that the moving body collides with a passerby outside the moving body on the basis of the first captured image;
determination means (for example, 404) for determining whether the driver visually recognizes the passerby on the basis of the second captured image; and
output control means (for example, 405) for causing an output device to output a warning at a warning level based on the calculated risk, characterized in that
when the driver visually recognizes the passerby, the output control means outputs a warning at a warning level lower than a warning level based on the same risk when the driver does not visually recognize the passerby (for example, 901, 902, 1001, 1102).

According to this embodiment, it is possible to issue an appropriate warning in consideration of the situation of the driver.

16. A storage medium of the above embodiment is a storage medium storing a program for causing a computer to function as each means of a driver-assistance apparatus (for example, 101) attached to a moving body (for example, 100), the driver-assistance apparatus comprising:
image capturing means (for example, 303) for acquiring a first captured image obtained by capturing a moving direction of the moving body and a second captured image obtained by capturing a driver of the moving body;
risk calculation means (for example, 403) for calculating a risk that the moving body collides with a passerby outside the moving body on the basis of the first captured image;
determination means (for example, 404) for determining whether the driver visually recognizes the passerby on the basis of the second captured image; and
output control means (for example, 405) for causing an output device to output a warning at a warning level based on the calculated risk, characterized in that
when the driver visually recognizes the passerby, the output control means outputs a warning (for example, 901, 902, 1001, 1102) at a warning level lower than a warning level based on the same risk when the driver does not visually recognize the passerby.

According to this embodiment, it is possible to issue an appropriate warning in consideration of the situation of the driver.

The invention is not limited to the foregoing embodiments, and various variations/changes are possible within the spirit of the invention.

What is claimed is:

1. A driver-assistance apparatus attached to a moving body, the driver-assistance apparatus comprising:
one or more processors; and
a memory storing instructions which, when the instructions are executed by the one or more processors, cause the driver-assistance apparatus to:
acquire a first captured image obtained by capturing a moving direction of the moving body and a second captured image obtained by capturing a driver of the moving body;
calculate a risk that the moving body collides with a passerby outside the moving body on the basis of the first captured image;
determine whether the driver visually recognizes the passerby on the basis of the second captured image; and
cause an output device to output a warning at a warning level based on the calculated risk,
wherein when the driver visually recognizes the passerby, the instructions cause the driver-assistance apparatus to output a warning at a warning level lower than a warning level based on the same risk when the driver does not visually recognize the passerby.

2. The driver-assistance apparatus according to claim 1, wherein the instructions cause the driver-assistance apparatus to output a warning at a first warning level when the risk is a first risk and the driver does not visually recognize the passerby, and output a warning at the first warning level when the driver visually recognizes the passerby even when the risk is a second risk higher than the first risk.

3. The driver-assistance apparatus according to claim 2, wherein the instructions cause the driver-assistance apparatus to output a warning at a warning level higher than the first warning level when a predetermined time elapses with the risk remaining at the second risk after outputting the warning at the first warning level.

4. The driver-assistance apparatus according to claim 2, wherein the instructions cause the driver-assistance apparatus to output a warning at a warning level higher than the first warning level when a predicted time until collision becomes shorter than a predetermined time with the risk remaining at the second risk after outputting the warning at the first warning level.

5. The driver-assistance apparatus according to claim 2, wherein the instructions cause the driver-assistance apparatus to output a warning at a warning level higher than the first warning level when the driver does not visually recognize the passerby after outputting the warning at the first warning level.

6. The driver-assistance apparatus according to claim 1, wherein the instructions cause the driver-assistance apparatus to output a warning accompanied by sound when the risk is higher than a predetermined risk value and the driver does not visually recognize the passerby.

7. The driver-assistance apparatus according to claim 1, wherein the instructions cause the driver-assistance apparatus not to output a warning accompanied by sound when the driver visually recognizes the passerby.

8. The driver-assistance apparatus according to claim 1, wherein the instructions cause the driver-assistance apparatus to cause the output device to output a warning indicating a direction in which the passerby is present.

9. The driver-assistance apparatus according to claim 8, wherein the instructions cause the driver-assistance apparatus to vary a display mode of a warning indicating a direction in which the passerby is present according to a warning level.

10. The driver-assistance apparatus according to claim 9, wherein the instructions cause the driver-assistance apparatus to display the warning in a display mode with higher saturation or brightness as the warning level is higher.

11. The driver-assistance apparatus according to claim 1, wherein the output device is included in the driver-assistance apparatus.

12. The driver-assistance apparatus according to claim 1, wherein the driver-assistance apparatus causes a display device of the output device to display the warning by communicating with the output device wirelessly or by wire.

13. The driver-assistance apparatus according to claim 11, wherein the output device is at least one of a smartphone, a tablet terminal, a head-mounted display, and a wearable terminal.

14. A driver-assistance method in which each step is executed by a driver-assistance apparatus attached to a moving body, the driver-assistance method comprising:
acquiring a first captured image obtained by capturing a moving direction of the moving body and a second captured image obtained by capturing a driver of the moving body;
calculating a risk that the moving body collides with a passerby outside the moving body on the basis of the first captured image;
determining whether the driver visually recognizes the passerby on the basis of the second captured image; and
causing an output device to output a warning at a warning level based on the calculated risk,
wherein when the driver visually recognizes the passerby, the causing a warning to be output includes causing a warning to be output at a warning level lower than a warning level based on the same risk when the driver does not visually recognize the passerby.

15. A non-transitory computer-readable storage medium storing instructions for executing a driver-assistance method in which each step is executed by a driver-assistance apparatus attached to a moving body, the driver-assistance method comprising:
acquiring a first captured image obtained by capturing a moving direction of the moving body and a second captured image obtained by capturing a driver of the moving body;
calculating a risk that the moving body collides with a passerby outside the moving body on the basis of the first captured image;
determining whether the driver visually recognizes the passerby on the basis of the second captured image; and
causing an output device to output a warning at a warning level based on the calculated risk,
wherein when the driver visually recognizes the passerby, the causing a warning to be output includes causing a warning to be output at a warning level lower than a warning level based on the same risk when the driver does not visually recognize the passerby.
